(19) United States
(12) Patent Application Publication
(10) Pub. No.: US 2023/0249515 A1
(43) Pub. Date: Aug. 10, 2023

(54) HEATING VENTILATION AND COOLING SYSTEM FOR A VEHICLE

(71) Applicant: Ford Global Technologies, LLC, Dearborn, MI (US)

(72) Inventors: Alan Gutowski, Wixom, MI (US); Manfred Koberstein, Troy, MI (US); Angelo Patti, Pleasant Ridge, MI (US)

(73) Assignee: Ford Global Technologies, LLC, Dearborn, MI (US)

(21) Appl. No.: 17/592,586

(22) Filed: Feb. 4, 2022

(51) Int. Cl. B60H 1/00

(52) U.S. Cl. CPC B60H 1/00764; B60H 1/00849; B60H 1/00828

(57) ABSTRACT

A method of operating a stop-start vehicle with an HVAC system that does not include an electric auxiliary coolant pump for circulating warm coolant to a heater core of the HVAC system in an engine-off condition of the vehicle comprises the steps of driving the vehicle via compulsion by an engine in an environment having an ambient outside temperature of about or less than 30 degrees Fahrenheit, entering an auto stop event, such that the engine enters the engine-off condition, and circulating heated air into a cabin of the vehicle in the engine-off condition for at least one minute. The heated air is circulated by decreasing the speed of a blower motor, adjusting a recirculation door position to increase air recirculation, and adjusting a temperature blend door position toward a full-heat position based on a sensed engine coolant temperature and a sensed evaporator core temperature.

### FIELD OF THE DISCLOSURE

The present disclosure generally relates to heating ventilation and cooling (HVAC) system for a vehicle. More specifically, the present disclosure relates to an HVAC system for a stop-start vehicle.

### BACKGROUND OF THE DISCLOSURE

HVAC systems of stop-start vehicles often utilize auxiliary, battery-powered coolant pumps to circulate coolant during auto stop events to allow for continued circulation of heated air in the engine-off condition.

### SUMMARY OF THE DISCLOSURE

According to a first aspect of the present disclosure, a method of operating a stop-start vehicle with an HVAC system that does not include an electric auxiliary coolant pump for circulating warm coolant to a heater core of the HVAC system in an engine-off condition of the vehicle includes the steps of driving the vehicle via compulsion by an engine in an environment having an ambient outside temperature of about or less than 30 degrees Fahrenheit, entering an auto stop event, such that the engine enters the engine-off condition, and circulating heated air into a cabin of the vehicle in the engine-off condition for at least one minute. The heated air is circulated by decreasing the speed of a blower motor, adjusting a recirculation door position to increase air recirculation, and adjusting a temperature blend door position toward a full-heat position based on a sensed engine coolant temperature and a sensed evaporator core temperature.

Embodiments of the first aspect of the present disclosure can include any one or a combination of the following features:
the step of decreasing the speed of the blower motor comprises decreasing the speed of the blower motor to a minimum operable blower motor speed;
the step of adjusting the recirculation door position to increase air recirculation comprises adjusting the recirculation door to a full air recirculation position;
the step of adjusting the recirculation door position to the full air recirculation position is dependent upon the blower motor speed decreasing below a predetermined threshold level;
the step of adjusting the recirculation door position to the full air recirculation position is further dependent upon a sensed ambient outside temperature being below a predetermined threshold temperature;
the predetermined threshold temperature is about 18.3 degrees Celsius;
the step of adjusting the temperature blend door position based on a sensed temperature of air within an air duct of the vehicle;
the step of decreasing the speed of the blower motor is responsive to a sensed ambient outside temperature;
the speed of the blower motor is decreased to a minimum operable blower speed responsive to the sensed ambient outside temperature being less than a predetermined threshold temperature; and
the predetermined threshold temperature is about 14 degrees Celsius.

According to a second aspect of the present disclosure, a method of operating a stop-start vehicle with an HVAC system includes the steps of controlling a blower motor at a first speed to circulate heated air into a cabin of the vehicle responsive to a first cabin climate setting according to a first HVAC operating strategy in an engine-on condition of the vehicle, entering an auto stop event, such that an engine enters the engine-off condition, and controlling the blower motor at a second speed that is less than the first speed to circulate heated air into the cabin of the vehicle responsive to the first cabin climate setting according to a second HVAC operating strategy during the auto stop event while the engine is in the engine-off condition.

Embodiments of the second aspect of the present disclosure can include any one or a combination of the following features:
the second speed is a minimum operable blower motor speed;
the steps of controlling a recirculation door position to control a level of air recirculation within the vehicle responsive to the first cabin climate setting according to the first HVAC operating strategy in the engine-on condition of the vehicle, and controlling the recirculation door position to increase the level of air recirculation within the vehicle responsive to the first cabin climate setting according to the second HVAC operating strategy during the auto stop event while the engine is in the engine-off condition;
the step of controlling the recirculation door position according to the second HVAC operating strategy comprises adjusting the recirculation door position to a full air recirculation position;
the step of adjusting the recirculation door position to the full air recirculation position is dependent upon the blower motor speed decreasing below a predetermined threshold level;
the steps of controlling a temperature blend door position based on a sensed engine coolant temperature responsive to the first cabin climate setting according to the first HVAC operating strategy in the engine-on condition of the vehicle, and feed-forward adjusting the temperature blend door position toward a full-heat position based on the sensed engine coolant temperature and a sensed evaporator core temperature responsive to the first cabin climate setting according to the second HVAC operating strategy during the auto stop event while the engine is in the engine-off condition; and
an adjustment rate of the temperature blend door position according to the first HVAC operating strategy is determined by a low pass filter, and an adjustment rate of the temperature blend door position is unattenuated according to the second HVAC operating strategy.

According to a third aspect of the present disclosure, a stop-start vehicle includes an engine operable between an engine-on condition and an engine-off condition, a blower motor that drives a blower to deliver air into a cabin of the vehicle, a temperature sensor for sensing the ambient temperature outside of the vehicle, and a controller that, responsive to the engine entering the engine-off condition due an auto stop event of the vehicle, prompts adjustment of the speed of the blower motor to a minimum operable blower motor speed based on the sensed ambient temperature outside of the vehicle.

Embodiments of a third aspect of the present disclosure can include any one or a combination of the following features:
the controller prompts adjustment of the speed of the blower motor to a minimum operable blower motor speed based on the sensed ambient temperature outside of the vehicle being less than a predetermined threshold temperature; and
the predetermined threshold temperature is about 14.0 degrees Celsius.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a block diagram of a vehicle illustrating a variety of vehicle components, according to one embodiment;

FIG. 2 is a schematic view of an HVAC air handling system, according to one embodiment;

FIG. 3 is a perspective and schematic view of a vehicle illustrating various vehicle components, according to one embodiment;

FIG. 4 is a flow diagram illustrating a method of operating a stop-start vehicle with an HVAC system, according to one embodiment; and

FIG. 5 is a flow diagram illustrating a method of operating a stop-start vehicle with an HVAC system, according to one embodiment.

### DETAILED DESCRIPTION OF THE PREFERRED EMBODIMENTS

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

The present illustrated embodiments reside primarily in combinations of method steps and apparatus components related to an HVAC system of a start-stop vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an” mean “at least one,” and should not be limited to “only one” unless explicitly indicated to the contrary. Thus, for example, reference to “a component” includes embodiments having two or more such components unless the context clearly indicates otherwise.

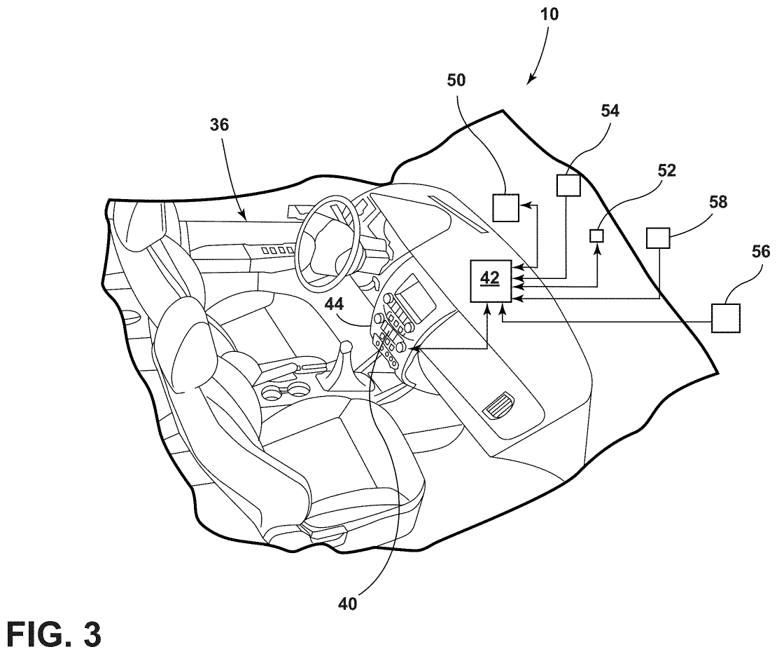

Referring now to FIG. 3, a schematic of a vehicle 10 with an internal combustion engine 12 is illustrated. The engine 12 is equipped with a start-stop feature wherein the engine 12 can be automatically shut off (enter an engine-off condition) during times when the engine 12 would otherwise be idling (e.g., when vehicle 10 is not moving) and then be automatically restarted (enter an engine-on condition) as necessary when the vehicle 10 begins to move again or when it becomes necessary to operate accessories off of the engine 12. An engine controller 14 is connected to the engine 12 for performing the start-stop functions. An auto stop event is initiated by the engine controller 14 under certain conditions, such as the vehicle 10 slowing to a stop. Such an event can be detected in response, in part, to the occurrence of a deceleration. In an exemplary embodiment, the deceleration is detected by monitoring the position of a brake pedal using an angle/position sensor that provides an angle signal representing the instantaneous brake pedal angle to controller 14.

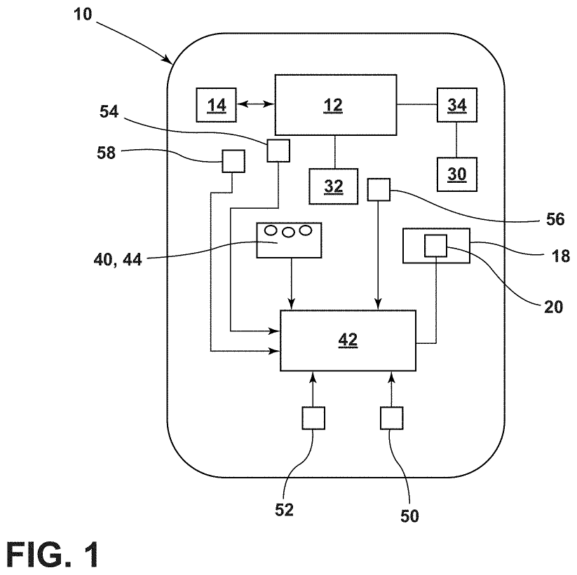

Referring now to FIG. 1, the vehicle 10 includes a heating, ventilation and air conditioning (HVAC) system 16. The HVAC system 16 includes a blower 18 that is driven by a blower motor 20. The blower 18 receives inlet air comprised of fresh air from a duct 22 and/or recirculated air from an air return vent 24 as determined by a position of a recirculation door 26. The recirculation door 26 functions to regulate air passing to the blower 18 between fresh air and recirculated air. The recirculation door 26 is operable between a full air recirculation position, a full fresh air position, and a plurality of positions therebetween. The HVAC system 16 also includes a temperature blend door 28. The temperature blend door 28 functions to regulate the mixture of warm air delivered past a heater core 30 and cool air delivered past an evaporator core 32. The temperature blend door 28 is operable between a full-heat position, a full-cool position, and a plurality of positions therebetween. The recirculation door 26 and the temperature blend door 28 (and various other doors of the HVAC system 16) may be driven by one or more of a variety of types of actuators (e.g., electric motors, vacuum controllers, etc.). In an exemplary embodiment, the recirculation door 26 may be driven by an electric servomotor such that the position of the recirculation door 26 may be variable.

The HVAC system 16 further includes heating and cooling elements. As illustrated in FIG. 1, the HVAC system 16 includes the heater core 30 that receives a flow of coolant heated by the internal combustion engine 12. The flow of coolant to the heater core 30 is propelled by a coolant pump 34 that is driven by the engine 12 while the engine 12 is in an engine-on condition. Heat from the heated coolant within the heater core 30 is transferred to air delivered over the heater core 30 by the blower 18, which, as described further herein, may be delivered into a cabin 36 of the vehicle 10 to heat the cabin 36. The HVAC system 16 further includes an evaporator core 32 that receives a flow of refrigerant from an air conditioning system 38. The evaporator core temperature may be controlled to allow the air conditioning system 38 to dehumidify air delivered thereover. The air conditioning system 38 may further include a compressor, a condenser, a refrigerant tank, a pressure cycling switch, and an expansion device for metering refrigerant to the evaporator core 32. A variety of other components are contemplated. As further illustrated in FIG. 1, the vehicle 10 includes a duct system 23 that includes various ducts 22 that facilitate air flow from the HVAC system 16 to various outlets and registers such as panel, defrost, and demister registers.

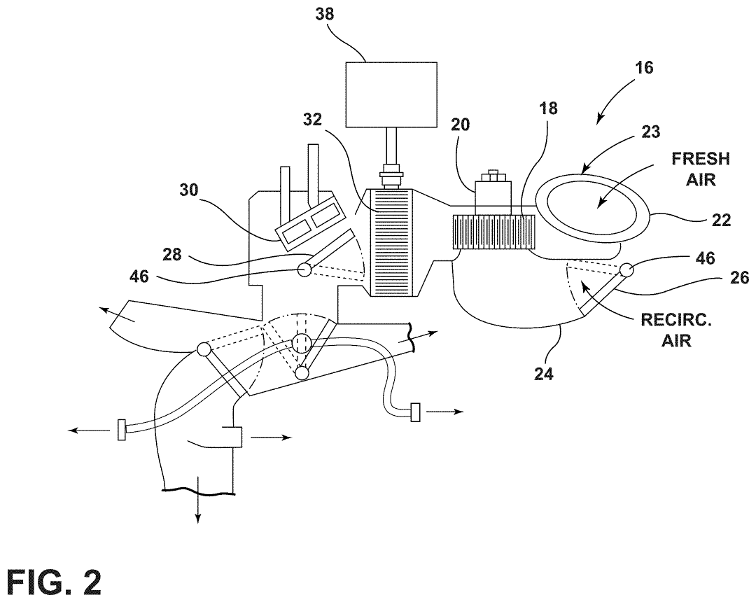

Referring now to FIG. 2, a human-machine interface (HMI) 40 for controlling the HVAC system 16 and/or other vehicle functions is configured to generate user input signals that are transmitted to a controller 42. In the embodiment illustrated in FIG. 2, the HMI 40 is an instrument-panel mounted HVAC control panel 44. The controller 42 responsively outputs control signals to control various components and/or systems of the vehicle 10 including, but not limited to, HVAC door actuators 46 (recirculation door actuator, temperature blend door actuator, etc.), the air conditioning system 38, the blower motor 20, and/or a combination thereof. It is contemplated that the controller 42 may be a shared or dedicated controller that includes a microprocessor and memory as illustrated, according to various embodiments. It should be appreciated that the controller 42 may include control circuitry such as analog and/or digital control circuitry. Stored within the memory and executed by the microprocessor is logic for processing the various inputs and controlling various outputs described herein.

Referring now to FIGS. 1-3, a variety of conditions inside and outside the cabin 36 of the vehicle 10 are monitored by a variety of sensors. The controller 42 may be coupled to the plurality of sensors (either directly or through a multiplex communication bus), which may include one or more of an ambient cabin temperature sensor 50 that senses the ambient air temperature within the cabin 36 of the vehicle 10, an ambient outside temperature sensor 52 that senses the ambient air temperature outside of the vehicle 10, an engine coolant temperature sensor 54 that senses the temperature of the engine 12 of the vehicle 10, an evaporator core temperature sensor 56 that senses the temperature of the evaporator core 32, and/or a duct temperature sensor 58 that senses the temperature of air flowing through the duct system 23 of the vehicle 10.

Referring now to FIGS. 1-3, a cabin climate setting may be communicated to the controller 42. The cabin climate setting may communicate a plurality of demanded cabin climate conditions. For example, the cabin climate setting may communicate a commanded ambient cabin temperature and/or a blower speed setting. Various other cabin climate conditions are contemplated (e.g., humidity, air flow zones, etc.). In some embodiments, the cabin climate setting may be set by a user via the HMI 40. For example, the user may set the cabin climate setting by adjusting the air flow amount and temperature of the air to the desired settings, and these settings may then be sent to controller 42. It is contemplated that, in some embodiments, the cabin climate setting may be adjusted automatically by the controller 42 via an automatic climate adjustment routine.

In the engine-on condition of the engine 12, the engine 12 drives the compressor of the air conditioning system 38, which circulates refrigerant to the evaporator core 32. Further, the engine 12 drives the coolant pump 34, which circulates coolant to the heater core 30. In the engine-on and engine-off conditions, the controller 42 can control operation of the blower motor 20 by prompting the blower motor 20 to operate at particular speeds. Further, the controller 42 can control various door actuators 46 of the HVAC system 16 in the engine-on and engine-off conditions of the engine 12 to prompt various doors, such as the temperature blend door 28 and the recirculation door 26, to enter various positions. In the engine-off condition, the compressor and coolant pump 34 are not driven by the blower motor 20. As such, the coolant within a coolant circuit may begin to cool and the refrigerant within the refrigerant circuit may begin to warm in the engine-off condition of the engine 12. In various embodiments, the vehicle 10 may not include a battery-powered auxiliary coolant pump that is operable to circulate coolant in the engine-off condition.

Referring still to FIGS. 1-3, in various embodiments, the HVAC system 16 may operate according to a first HVAC operating strategy in the engine-on condition of the vehicle 10 and may operate according to a second HVAC operating strategy in the engine-off condition of the vehicle 10. A variety of HVAC system components may be controlled in a first manner in response to a cabin climate setting according to the first HVAC operating strategy in the engine-on condition, and the components may be controlled in a second manner in response to the same cabin climate setting according to the second HVAC operating strategy in the engine-off condition.

In various embodiments, at least one of the blower motor 20, the recirculation door 26, and/or the temperature blend door 28 may be controlled in a first manner according to the first HVAC operating strategy and controlled in a second manner according to the second HVAC operating strategy. In some embodiments, wherein the cabin climate setting demands that heated air (i.e., air that is warmer than the ambient cabin air temperature) is circulated into the cabin 36 of the vehicle 10, the vehicle 10 transitioning from the engine-on condition to the engine-off condition and the HVAC system 16 transitioning from the first HVAC operating strategy to the second HVAC operating strategy may result in the controller 42 (1) prompting adjustment of the speed of the blower motor 20 to a decreased speed, (2) prompting adjustment of the recirculation door position toward the full recirculation position, and/or (3) prompting feed-forward adjustment of the temperature blend door 28 toward the full-heat position.

In various embodiments, the controller 42 may prompt adjustment of the speed of the blower motor 20 to a minimum operable blower motor speed. In other words, the controller 42 may adjust the blower motor 20 to a speed resulting from a minimum application of voltage to the blower motor 20 that allows the blower motor 20 to run without stalling. Further, in some embodiments, the controller 42 may prompt adjustment of the speed of the blower 18 based on the sensed ambient outside temperature sensed by the ambient outside temperature sensor 52. For example, the controller 42 may prompt adjustment of the speed of the blower motor 20 to the minimum operable blower motor speed based on the sensed ambient outside temperature being less than a first predetermined threshold temperature. In some embodiments, the first predetermined threshold temperature may be about 14.0 degrees Celsius.

With continued reference to the aforementioned scenario, wherein the cabin climate setting demands that heated air is circulated into the cabin 36 of the vehicle 10, the HVAC system 16 entering the second operating strategy as the vehicle 10 enters the engine-off condition may result in the controller 42 prompting adjustment of the recirculation door position toward the full recirculation position. In some embodiments, the controller 42 may prompt adjustment of the recirculation door position to the full recirculation position. In some implementations, in response to the aforementioned scenario, the controller 42 may prompt adjustment of the recirculation door position toward the full recirculation position based on blower motor 20 speed and/or the ambient outside temperature. For example, the controller 42 may prompt the adjustment of the position of the recirculation door 26 to the full air recirculation position based on the blower motor 20 speed decreasing below a predetermined threshold level and/or based on the sensed ambient outside temperature being below a second predetermined threshold temperature. In an exemplary embodiment, the second predetermined threshold temperature may be about 18.3 degrees Celsius.

With continued reference to the aforementioned scenario, the controller 42 may responsively prompt feed-forward adjustment of the temperature blend door position toward the full-heat position based on sensed engine coolant temperature and the sensed evaporator core temperature. In some implementations, the adjustment rate of the temperature blend door position is unattenuated according to the second HVAC strategy. Conversely, the adjustment rate of the temperature blend door 28 in the first HVAC operating strategy may be attenuated via the application of a low pass filter, as described further herein.

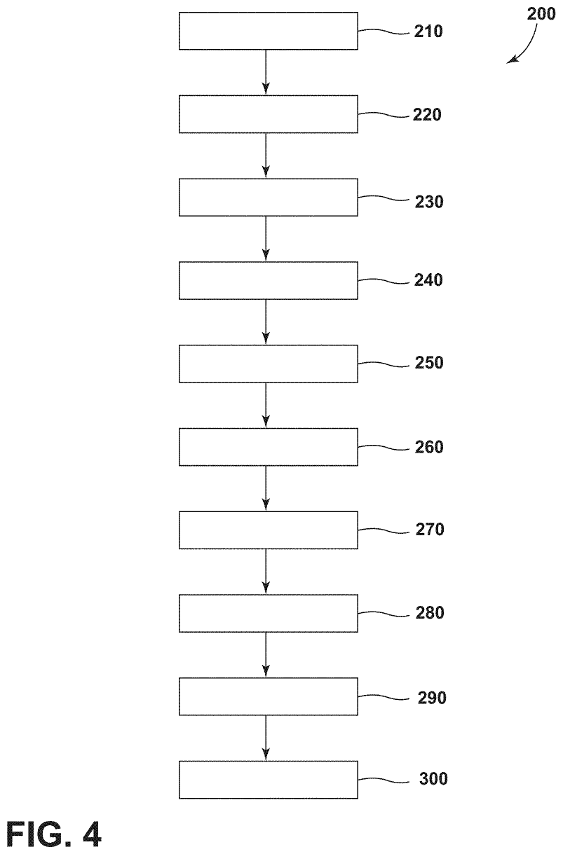

Referring now to FIG. 4, a method 200 of operating the stop-start vehicle 10 includes the step 210 of operating the vehicle 10 in the engine-on condition. In various embodiments, this may entail driving the vehicle 10 via compulsion by the engine 12. The method 200 further includes the step 220 of controlling the HVAC system 16 of the vehicle 10 responsively to a first cabin climate setting according to the first HVAC operating strategy in the engine-on condition of the vehicle 10. In some implementations, the first cabin climate setting may demand at least one cabin climate condition. For example, the first cabin climate setting may demand an increased ambient air temperature within the cabin 36 of the vehicle 10. As such, the step 220 of controlling the HVAC system 16 responsively to the first cabin climate setting according to the first HVAC operating strategy may entail controlling the HVAC system 16 to circulate heated air into the cabin 36 of the vehicle 10.

In various embodiments, the step 220 of controlling the HVAC system 16 of the vehicle 10 responsively to the first cabin climate setting according to the first HVAC operating strategy to circulate heated air into the cabin 36 of the vehicle 10 may be performed via one or more sub-steps. For example, the step 220 may include the step 230 of controlling the blower motor 20 of the HVAC system 16 to circulate heated air into the cabin 36 of the vehicle 10 responsively to the first cabin climate setting request according to the first HVAC operating strategy. In some implementations, the step 230 includes controlling the blower motor 20 of the HVAC system 16 at a first speed to circulate heated air into the cabin 36 of the vehicle 10 responsively to the first cabin climate setting request according to the first HVAC operating strategy. Various speeds are contemplated based on the demanded climate conditions that correspond with the first HVAC operating strategy and various sensed environmental conditions (e.g., ambient outside air temperature, ambient cabin air temperature, heater core temperature, etc.) communicated to the controller 42.

In some implementations, the step 220 may include the step 240 of controlling the recirculation door position to control the level of air recirculation within the vehicle 10 responsively to the first cabin climate setting according to the first HVAC operating strategy in the engine-on condition of the vehicle 10. The recirculation door position may be controlled via the controller 42 prompting movement of the recirculation door actuator 46. It is contemplated that the controller 42 may prompt movement of the recirculation door 26 based on the demanded climate conditions that correspond with the first cabin climate setting and various sensed environmental conditions (e.g., ambient outside air temperature, ambient cabin air temperature, heater core temperature, etc.) communicated to the controller 42.

In some implementations, the step 220 may include the step 250 of controlling the temperature blend door position responsively to the first cabin climate setting according to the first HVAC operating strategy in the engine-on condition of the vehicle 10. In various embodiments, the temperature blend door position is controlled based on the temperature sensed by the engine coolant temperature sensor 54 as well as the demanded climate conditions that correspond with the first cabin climate setting. At step 250 the adjustment rate of the temperature blend door position according to the first HVAC operating strategy may be determined by a low pass filter, such that adjustment of the temperature blend door position may be attenuated. In various implementations, the temperature blend door position may be adjusted based on a sensed temperature of air within an air duct 22 of the vehicle 10 as sensed by the duct temperature sensor 58.

Referring still to FIG. 4, the method 200 further includes the step 260 of entering an auto stop event, such that the engine 12 enters the engine-off condition. As described herein, the auto stop event is initiated by the engine controller 14 under certain conditions, such as the vehicle 10 slowing to a stop. In the engine-off condition, the coolant pump 34 that is operably coupled to the engine 12 ceases to pump coolant through the heater core 30.

The method 200 further includes the step 270 of controlling the HVAC system 16 of the vehicle 10 responsively to the first cabin climate setting (i.e., the same cabin climate setting as step 220) according to the second HVAC operating strategy in the engine-off condition of the vehicle 10. The second HVAC operating strategy in the engine-off condition may be different than the first HVAC operating strategy in the engine-on condition due to the various factors stemming from the engine 12 not running in the engine-off condition (e.g., resulting interruption of coolant circulation, etc.). As such, various sub-steps of the step 270 of controlling the HVAC system 16 responsively to the first cabin climate setting according to the second HVAC operating strategy may differ from the sub-steps of the step 220 of controlling the HVAC system 16 responsively to the first cabin climate setting according to the first HVAC operating strategy.

In various embodiments, the step 270 may include the step 280 of controlling the blower motor 20 of the HVAC system 16 to circulate heated air into the cabin 36 of the vehicle 10 responsively to the first cabin climate setting request according to the second HVAC operating strategy. In some implementations, the step 280 includes controlling the blower motor 20 of the HVAC system 16 at a second speed to circulate heated air into the cabin 36 of the vehicle 10 responsively to the first cabin climate setting according to the second HVAC operating strategy. The second speed of the blower motor 20 of step 280 may be less than the first speed of the blower motor 20 of step 230. In some implementations, that second speed of the blower motor 20 may be the minimum operable blower motor speed. It is contemplated that in some embodiments the first cabin climate setting may include a demanded blower speed setting. For example, the first cabin climate setting may include a demanded blower speed that is equal to the first blower speed of step 230. In such embodiments, the second blower speed of step 280 may be less than the first blower speed, despite the first cabin climate setting remaining in effect, to allow for continued circulation of heated air into the cabin 36 of the vehicle 10 in the engine-off condition.

In some embodiments, the step 280 of controlling the blower motor 20 of HVAC system 16 to circulate heated air into the cabin 36 of the vehicle 10 responsively to the first cabin climate setting request according to the second HVAC operating strategy may include controlling the blower motor 20 at the second speed based on the ambient outside temperature being below a threshold temperature. For example, controlling the blower motor 20 to the minimum operable blower motor speed may be dependent upon the outdoor ambient temperature being below a threshold temperature. In other words, at step 280, the blower motor 20 may be controlled to operate at the minimum operable blower motor speed if the ambient outside temperature is below the threshold temperature. In some embodiments, the ambient outside threshold temperature upon which the blower speed 20 depends may be about 14.0 degrees Celsius.

The step 270 may include the step 290 of controlling the recirculation door position to increase the level of air recirculation within the vehicle 10 responsively to the first cabin climate setting according to the second HVAC operating strategy in the engine-off condition of the vehicle 10. In some implementations, the step 290 of controlling the recirculation door position according to the second HVAC operating strategy comprises adjusting the recirculation door 26 to the full air recirculation position. In some embodiments, the recirculation door 26 may be adjusted to the full air recirculation position at step 290 based on the blower motor speed and/or ambient outside temperature. For example, the recirculation door 26 may be adjusted to the full recirculation position at step 290 based on the blower motor speed decreasing below a predetermined threshold level. The predetermined threshold level may correspond with a blower speed option provided by the HMI 40 to the user (e.g., low speed, medium speed, high speed, etc.). In some examples, the recirculation door 26 may be adjusted to the full air recirculation position at step 290 based on the outside ambient air being below a threshold temperature. In some implementations, the threshold temperature may be about 18.3 degrees Celsius. Various threshold temperatures are contemplated.

In an exemplary embodiment, the step 290 of controlling the recirculation door position according to the second HVAC operating strategy in the engine-off condition of the vehicle 10 responsively to the first cabin climate setting comprises adjusting the recirculation door 26 to the full air recirculation position based on the speed of the blower motor 20 decreasing below the predetermined threshold level and based on the sensed outside ambient air temperature being below the predetermined threshold temperature.

The step 270 may further include the step 300 of controlling the temperature blend door position responsively to the first cabin climate setting according to the second HVAC operating strategy in the engine-off condition of the vehicle 10. In some embodiments, the step 300 may include feed-forward adjusting the temperature blend door position toward the full-heat position based on sensed engine coolant temperature and sensed evaporator core temperature responsive to the first cabin climate request according to the second HVAC operating strategy in the engine-off condition. In some implementations, at step 300, the adjustment rate of the temperature blend door position is unattenuated according to the second HVAC strategy, such that delayed adjustment of the temperature blend door position due to a low pass filter, as described in reference to step 250 herein, is avoided. In various implementations, the temperature blend door position may be adjusted based on a sensed temperature of air within an air duct 22 of the vehicle 10 as sensed by the duct temperature sensor 58.

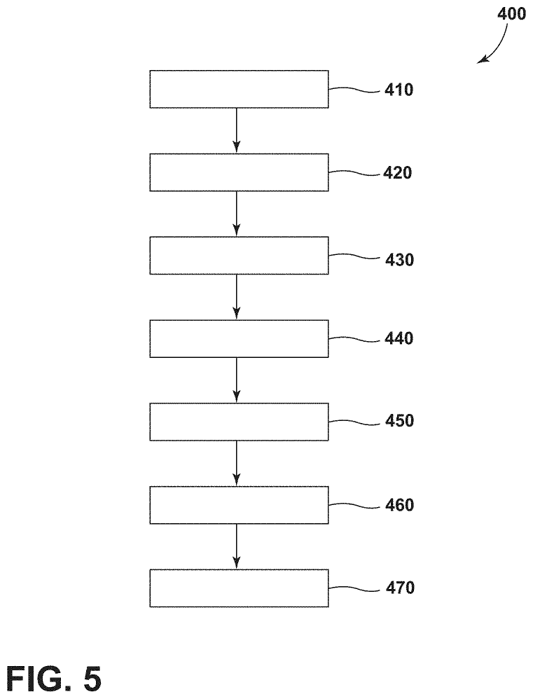

Referring now to FIG. 5, a method 400 of operating a stop-start vehicle 10 with an HVAC system 16 that does not include an electric auxiliary coolant pump 34 for circulating warm coolant to the heater core 30 of the HVAC system 16 in the engine-off condition of the vehicle 10 is illustrated. The method 400 includes the step 410 of driving the vehicle 10 via compulsion by the engine 12 in an environment having an ambient outside temperature of about or less than 30 degrees Fahrenheit. The method 400 further includes step 420 of entering an auto stop event, such that the engine 12 enters the engine-off condition. The method 400 further includes the step 430 of circulating heated air into the cabin 36 of the vehicle 10 in the engine-off condition for at least one minute.

In various embodiments, the step 430 may be performed via performance of various sub-steps. For example, step 430 may be performed via performance of at least one of the step 440 of decreasing the speed of the blower motor 20, the step 450 of adjusting the recirculation door position to increase air recirculation, and the step 460 of feed-forward adjusting the temperature blend door position toward a full-heat position based on a sensed engine coolant temperature and a sensed evaporator core temperature.

In some embodiments, the step 440 of decreasing the speed of the blower motor 20 comprises decreasing the speed of the blower motor 20 to the minimum operable blower motor speed. The step 440 of decreasing the speed of the blower motor 20 may be responsive to a sensed ambient outside temperature. In some implementations, the speed of the blower motor 20 may be decreased to a minimum operable blower speed responsive to the sensed ambient outside temperature being less than a predetermined threshold temperature. The predetermined threshold temperature may be about 14 degrees Celsius.

In some embodiments, the step 450 of adjusting the recirculation door position to increase air recirculation comprises adjusting the recirculation door position to the full air recirculation position. The step 450 of adjusting the recirculation door position to the full air recirculation position may be dependent upon the blower motor speed decreasing below a predetermined threshold level. The step 450 of adjusting the recirculation door position to the full air recirculation position may be further dependent upon a sensed ambient outside temperature being below a predetermined threshold temperature. In some embodiments, the predetermined threshold temperature may be about 18.3 degrees Celsius.

The method 400 may further include the step 470 of adjusting the temperature blend door position based on a sensed temperature of the air within the air duct 22 of the vehicle 10. The temperature of the air within the air duct 22 may be sensed by the duct temperature sensor 58.

The HVAC system 16 of the present disclosure may provide a variety of advantages. First, adjustment of the blower motor speed, recirculation door position, and temperature blend door position when the second HVAC operating strategy is entered may allow the HVAC system 16 to continue providing heated air to the cabin 36 of the vehicle 10 in the engine-off condition of the vehicle 10 without the use of an auxiliary coolant pump. Second, the adjustment of the recirculation door position to the full recirculation position being dependent upon the blower motor speed being below the predetermined threshold level may ensure that noise levels from the HVAC system 16 are kept below undesirable levels.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method of operating a stop-start vehicle with an HVAC system that does not include an electric auxiliary coolant pump for circulating warm coolant to a heater core of the HVAC system in an engine-off condition of the vehicle, comprising the steps of:
driving the vehicle via compulsion by an engine in an environment having an ambient outside temperature of about or less than 30 degrees Fahrenheit;
entering an auto stop event, such that the engine enters the engine-off condition; and
circulating heated air into a cabin of the vehicle in the engine-off condition for at least one minute by:
decreasing the speed of a blower motor;
adjusting a recirculation door position to increase air recirculation; and
adjusting a temperature blend door position toward a full-heat position based on a sensed engine coolant temperature and a sensed evaporator core temperature.

2. The method of claim 1, wherein the step of decreasing the speed of the blower motor comprises decreasing the speed of the blower motor to a minimum operable blower motor speed.

3. The method of claim 1, wherein the step of adjusting the recirculation door position to increase air recirculation comprises adjusting the recirculation door to a full air recirculation position.

4. The method of claim 3, wherein the step of adjusting the recirculation door position to the full air recirculation position is dependent upon the blower motor speed decreasing below a predetermined threshold level.

5. The method of claim 4, wherein the step of adjusting the recirculation door position to the full air recirculation position is further dependent upon a sensed ambient outside temperature being below a predetermined threshold temperature.

6. The method of claim 5, wherein the predetermined threshold temperature is about 18.3 degrees Celsius.

7. The method of claim 1, further comprising the step of:
adjusting the temperature blend door position based on a sensed temperature of air within an air duct of the vehicle.

8. The method of claim 1, wherein the step of decreasing the speed of the blower motor is responsive to a sensed ambient outside temperature.

9. The method of claim 8, wherein the speed of the blower motor is decreased to a minimum operable blower speed responsive to the sensed ambient outside temperature being less than a predetermined threshold temperature.

10. The method of claim 9, wherein the predetermined threshold temperature is about 14 degrees Celsius.

11. A method of operating a stop-start vehicle with an HVAC system, comprising the steps of:
controlling a blower motor at a first speed to circulate heated air into a cabin of the vehicle responsive to a first cabin climate setting according to a first HVAC operating strategy in an engine-on condition of the vehicle;
entering an auto stop event, such that an engine enters the engine-off condition; and
controlling the blower motor at a second speed that is less than the first speed to circulate heated air into the cabin of the vehicle responsive to the first cabin climate setting according to a second HVAC operating strategy during the auto stop event while the engine is in the engine-off condition.

12. The method of claim 11, wherein the second speed is a minimum operable blower motor speed.

13. The method of claim 11, further comprising the steps of:
controlling a recirculation door position to control a level of air recirculation within the vehicle responsive to the first cabin climate setting according to the first HVAC operating strategy in the engine-on condition of the vehicle; and
controlling the recirculation door position to increase the level of air recirculation within the vehicle responsive to the first cabin climate setting according to the second HVAC operating strategy during the auto stop event while the engine is in the engine-off condition.

14. The method of claim 13, wherein the step of controlling the recirculation door position according to the second HVAC operating strategy comprises adjusting the recirculation door position to a full air recirculation position.

15. The method of claim 14, wherein the step of adjusting the recirculation door position to the full air recirculation position is dependent upon the blower motor speed decreasing below a predetermined threshold level.

16. The method of claim 11, further comprising the steps of:
controlling a temperature blend door position based on a sensed engine coolant temperature responsive to the first cabin climate setting according to the first HVAC operating strategy in the engine-on condition of the vehicle; and
feed-forward adjusting the temperature blend door position toward a full-heat position based on the sensed engine coolant temperature and a sensed evaporator core temperature responsive to the first cabin climate setting according to the second HVAC operating strategy during the auto stop event while the engine is in the engine-off condition.

17. The method of claim 16, wherein an adjustment rate of the temperature blend door position according to the first HVAC operating strategy is determined by a low pass filter, and an adjustment rate of the temperature blend door position is unattenuated according to the second HVAC operating strategy.

18. A stop-start vehicle, comprising:
an engine operable between an engine-on condition and an engine-off condition;
a blower motor that drives a blower to deliver air into a cabin of the vehicle;
a temperature sensor for sensing the ambient temperature outside of the vehicle; and
a controller that, responsive to the engine entering the engine-off condition due an auto stop event of the vehicle, prompts adjustment of the speed of the blower motor to a minimum operable blower motor speed based on the sensed ambient temperature outside of the vehicle.

19. The stop-start vehicle of claim 18, wherein the controller prompts adjustment of the speed of the blower motor to a minimum operable blower motor speed based on the sensed ambient temperature outside of the vehicle being less than a predetermined threshold temperature.

20. The stop-start vehicle of claim 19, wherein the predetermined threshold temperature is about 14.0 degrees Celsius.
